(19) United States
(12) Patent Application Publication
(10) Pub. No.: US 2022/0297916 A1
(43) Pub. Date: Sep. 22, 2022

(54) FOOD WRAP

(71) Applicant: Polymeric Film & Bags, Inc., Naples, FL (US)

(72) Inventor: Fredric Leiter, Naples, FL (US)

(21) Appl. No.: 17/805,560

(22) Filed: Jun. 6, 2022

Related U.S. Application Data
(63) Continuation-in-part of application No. 17/197,780, filed on Mar. 10, 2021.
(60) Provisional application No. 63/198,291, filed on Oct. 8, 2020.

(51) Int. Cl. B65D 81/34; B65D 65/42; B32B 27/36; B32B 27/08; B32B 27/10; B32B 7/12

(52) U.S. Cl. CPC B65D 81/3461; B65D 65/42; B32B 27/36; B32B 27/08; B32B 27/10; B32B 7/12; B65D 2581/3472; B32B 2250/03; B32B 2255/20; B32B 2255/26; B32B 2255/10; B32B 2255/12; B32B 2307/31; B32B 2307/752; B32B 2307/732; B32B 2307/7242; B32B 2307/718; B32B 2307/748; B32B 2439/70; B32B 2037/243

(57) ABSTRACT

A microwavable food wrap includes a sealable first polymer film layer having a first surface, a second surface opposite the first surface, wherein the first polymer layer comprises a sealable polymer material, a second polymer film layer having a first surface covering the second surface of the first polymer film layer, and a second surface opposite the first surface of the second polymer layer, a metal oxide layer covering at least a majority of one of the surfaces of the first and second polyester film layers, and a paper layer coupled to the second polymer film layer.

### CROSS-REFERENCE TO RELATED APPLICATIONS

This application is a continuation-in-part of U.S. patent application Ser. No. 17/197,780, filed Mar. 10, 2010, entitled “PET SANDWICH LAYER,” which claims priority to U.S. Provisional Patent Application No. 63/198,291, filed Oct. 8, 2020, entitled “PET SANDWICH LAYER,” the entire disclosures of which are incorporated herein.

### BACKGROUND

The embodiments disclosed herein relate to a wrap for packaging foods, and in particular to a wrap that includes various polymer, paper and metal oxide layers configured to sufficiently wrap and store foods, such as sandwiches, in a point of sale presentation form while allowing for convection, conduction, radiant and microwave heating and providing improved heat retention, wrapping convenience and a transfer barrier to gas and liquid.

### BRIEF SUMMARY

One aspect of the embodiment(s) disclosed herein may include a food wrap configured to be heated that includes a sealable first polymer film layer having a first surface, a second surface opposite the first surface, wherein the first polymer layer comprises a sealable polymer material, a second polymer film layer having a first surface covering the second surface of the first polymer film layer, and a second surface opposite the first surface of the second polymer layer, a metal oxide layer covering at least a majority of one of the surfaces of the first and second polyester film layers, and a paper layer coupled to the second polymer film layer and having a grammage of within a range of between about 25 g/m² and about 80 g/m².

Another aspect of the embodiment(s) disclosed herein may in addition or alternatively include a food wrap configured to be heated that includes a food-safe, sealable polymer film layer having a first surface and a second surface opposite the first surface, a metal oxide layer covering at least a majority of one of the surfaces of the sealable polyester film layer, and a paper layer coupled to the second polymer film layer and having a grammage of within a range of between about 25 g/m² and about 80 g/m².

Yet another aspect of the embodiment(s) disclosed herein may in addition or alternatively include a method for manufacturing a microwavable wrap for wrapping foods that includes providing at least one food-safe, sealable polymer film layer having a first surface and a second surface opposite the first surface, covering at least a majority of one of the surfaces of the polymer film layer with a metal oxide layer, providing a paper layer having a grammage of within a range of between about 25 g/m² and about 80 g/m², coupling the paper layer to the polymer film layer and the metal oxide layer, and sealing a first portion of the at least one polymer film layer to a second portion of the at least one polymer film layer.

Still yet another aspect of the embodiment(s) disclosed herein may in addition or alternatively include a method for manufacturing a food storage arrangement that includes providing at least one food-safe, sealable polymer film layer having a first surface and a second surface opposite the first surface, covering at least a majority of one of the surfaces of the at least one polymer film layer with a metal oxide layer, providing a paper layer, coupling the paper layer to the at least one polymer film layer and the metal oxide layer, providing a food container that is separate from the at least one polymer film layer, the food container having at least one side edge, and sealing the at least one polymer film layer to the at least one side edge of the food container thereby defining a storage area for storing food stuffs therein.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a cross-sectional perspective view of an embodiment of a wrap for packaging foods;

FIG. 2 is a schematic flow chart of a method for manufacturing the wrap for packaging foods as shown in FIG. 1;

FIG. 3 is a cross-section perspective view of an alternative embodiment of the wrap for packaging foods;

FIG. 4 is a schematic flow chart of a method for manufacturing the food wrap for packaging foods as shown in FIG. 3;

FIG. 5 is a cross-sectional perspective view of another alternative embodiment of the wrap for packaging foods;

FIG. 6 is a top plan view of a bag for packaging foods comprising the wrap for packaging foods; and

FIG. 7 is a food container arrangement for packaging foods that includes the wrap for packaging foods.

### DETAILED DESCRIPTION

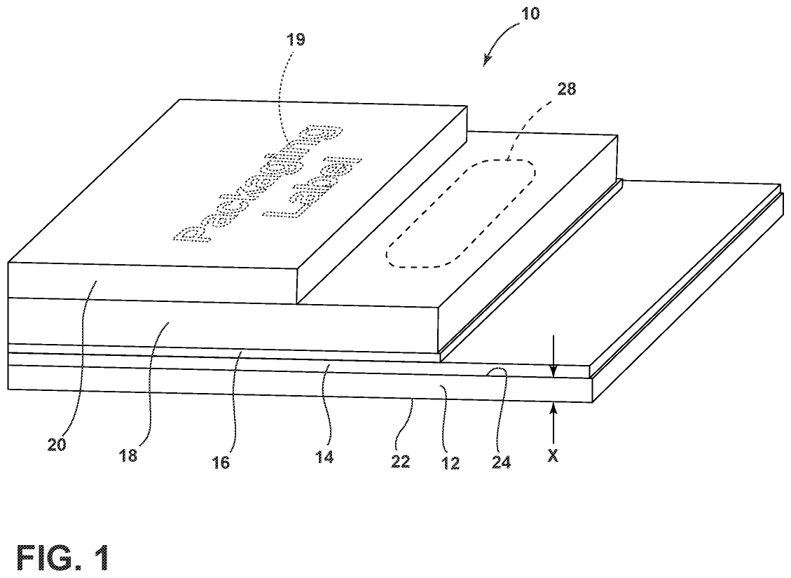

For purposes of description herein, the terms “upper,” “lower,” right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

The reference numeral 10 (FIG. 1) generally designates a multi-layer food wrap configured to wrap ovenable/heated foods, including foods heated via convection, conduction, radiant and microwave heating methods. In the illustrated example, the wrap 10 may include a polymer film layer 12, a barrier layer 14, an adhesive layer 16, a paper layer 18, and an ink label 19, and a protective overlay 20. The wrap 10 is configured to sufficiently wrap and store foods, such as sandwiches, in a point of sale presentation form while allowing for convection, conduction, radiant and microwave heating. The wrap 10 may also be utilized for other applications where the function of wrapping a given item and subsequently retaining heat within the item is advantageous.

In the illustrated example, the polymer film layer 12 may comprise polyester, and more particularly a polyethylene terephthalate. When comprising polyester, the polymer film layer 12 may include a biaxially oriented polyester to provide the food wrap 10 with an increased tensile strength and a resistance to tensile elongation. Preferably, the polymer film layer 12 is substantially transparent, however the polymer film layer 12 may also be provided in a translucent or opaque form depending upon the requirements of the application. For instance, certain applications may require that the food packaged within the overall food wrap 10 be visible at least through certain or preselected portions of the overall food wrap 10, while other portions of the overall food wrap 10 remain either translucent and/or opaque, as described below. As best illustrated in FIG. 1, the polymer film layer 12 includes a first surface 22 and a second surface 24 opposite the first surface 22, wherein the first and second surfaces 22, 24 cooperate to define a thickness X of the polymer film layer 12 there between. Preferably, the polymer film layer 12 has a thickness X of within the range of between about 6 μm and about 30 μm, more preferably a thickness X of within the range of between about 10 μm and about 18 μm, and most preferably of about 12 μm. In another embodiment, the polymer film layer 12 may be replaced with a film layer that in addition or alternatively to the polymer material, comprises nylon. When comprising nylon, the film layer may include nylon 6 or nylon 6,6, and may comprise a biaxially oriented nylon.

The barrier layer 14 may comprise a metal oxide, and preferably comprises aluminum oxide, where the barrier layer 14 is configured as a thermal, gas and/or moisture barrier. Alternatively, silicon oxide may also be utilized with or as a replacement to the metal oxide depending on the requirements of the application. The metal oxide, and in particular the aluminum oxide, provides an improved thermal, gas and moisture barrier when combined with the polymer film layer 12, and in particular to the polymer film layer 12 comprising polyester and/or the film layer comprising polyester and/or nylon. It is noted that the metal oxide layer, and in particular the aluminum oxide layer, when combined with the polymer film layer 12, is configured to allow microwave heating of any wrapped food materials, and improves heat retention of the food article regardless of the method utilized to heat the wrapped food item. In the illustrated example, the barrier layer 14, and in particular when comprising aluminum oxide, may be provided as a coating on the second surface 24 of the polymer film layer 12. An example of a combined polymer film layer 12 and barrier layer 14 includes ECOSYAR:VE100 as available from Toyobo Co., Ltd. of Osaka, Japan. Preferably, the combined polymer film layer 12 and barrier layer 14 comprises a biaxially oriented polyester having a thickness of approximately 12 μm, a haze of approximately 2.6 percent, a machine direction tensile strength of about 220 MPa, a transverse direction tensile strength of about 230 MPa, a machine direction tensile elongation of about 100 percent, a transverse direction tensile elongation of about 95 percent, a water vapor transmission rate of about 2 g/m²·day, and an oxygen transmission rate of about 20 ml/m²·day·MPa. Preferably, the barrier layer 14 is applied to the polymer film layer 12 via a vacuum metalizing process.

The paper layer 18 comprises a food grade wrapping paper, and may include a waterproof or greaseproof food grade wrapping paper. In the illustrated example, the paper layer 18 has a grammage of within the range of from about 25 g/m² to 80 g/m², more preferably of within the range of from about 30 g/m² to 40 g/m², and most preferably of about 35 g/m², where grammage is the area density of the paper. The paper layer 18 is adhered to the polymer film layer 12 and the barrier layer 14 via the adhesive layer 16. In the illustrated example, the adhesive layer 16 is configured to adhere the paper layer to the polymer film layer 12 and the barrier layer 14 via a dry lamination process, such as EA-N6000-DM-KR as available from Toyochem Specialty Chemical SDN. BHD. of Seremban, Malaysia. Alternatively, the coating layer 20 may be adhered to the polymer film layer 12 and barrier layer 14 via other methods, including vibrational welding, heat welding, compression welding, wet lamination, and the like. As noted above, the paper layer 18 may be coated with the coating layer 20 subsequent to ink printing the label 19 on an outer, exposed surface of the paper layer 18, thereby allowing direct labelling of the overall food wrap 10 to identify the food either for storage or for display in point of sale purposes. Preferably, the coating layer 20 comprises, a varnish overlay configured to protect the ink label 19, such as CORKOTE™-69KFP-1, as available from Cork Ind. of Folcroft, Pa.

In one embodiment, the paper layer 18 may be provided with an aperture 28 so as to allow at least a portion of the food article contained within the food wrap 10 to be viewed through the transparent or translucent polymer film layer 12. In certain configurations, the food wrap 10 may then be configured to allow viewing of the food item within the food wrap 10 while simultaneously completely wrapping the food item and providing a printable surface over certain portions of the paper layer 18.

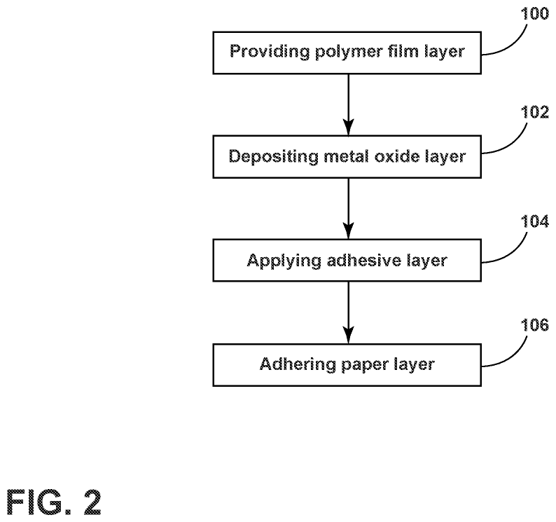

The food wrap 10 may be manufactured via a method (FIG. 2) that includes providing the polymer film layer 12 or film layer (step 100), depositing the barrier layer 14 on the second surface 24 of the polymer film layer 12 via a vacuum metalizing process (step 102), applying the adhesive layer 16 to the combination of the polymer film layer 12 and the barrier layer 14 (step 104), and adhering the paper layer 18 or a combination of the paper layer 18, the ink label and the overlay 20 to the combination of the polymer film layer 12 of film layer and the barrier layer 14 via the adhesive layer 16 via a dry lamination process.

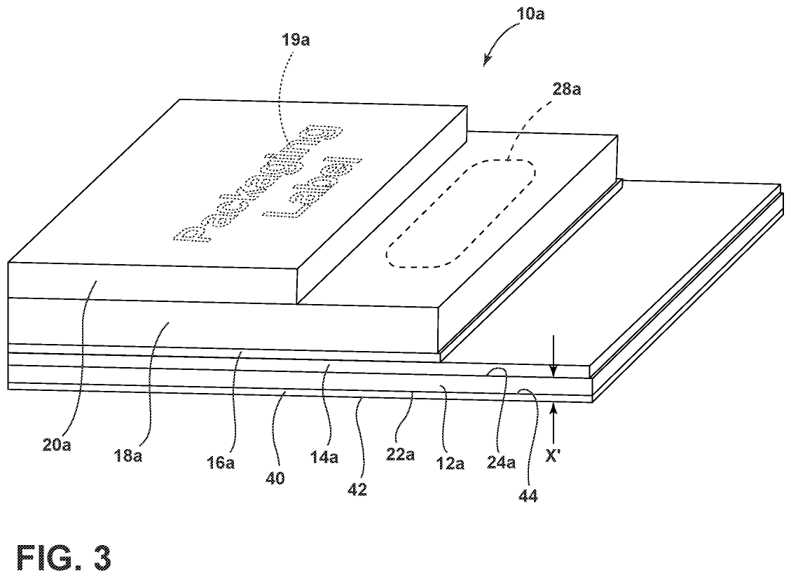

The reference numeral 10a (FIG. 3) generally designates another embodiment of the multi-layer food wrap also configured to wrap ovenable/heated foods, including foods heated via convection, conduction, radiant and microwave heating methods. Since the food wrap 10a is similar to the previously described food wrap 10, similar parts and/or elements appearing in FIG. 1 and FIG. 3 respectively, are represented by the same, corresponding reference numeral, except for the suffix “a” in the numerals of the latter. In the illustrated example, the wrap 10a may include a first polymer film layer 40, a second polymer film layer 12a, a barrier layer 14a, an adhesive layer 16a, a paper layer 18a, and an ink label 19a, and a protective overlay 20a, where the barrier layer 14a, the adhesive layer 16a, the paper layer 18a, the ink label 19a and the protective layer 20a may be similar in composition and thickness as the corresponding and previously described barrier layer 14, the adhesive layer 16, the paper layer 18, the ink label 19 and the protective layer 20.

In the illustrated example, the first and second polymer film layers 40, 12a may each comprise polyester, and more particularly a polyethylene terephthalate. When comprising polyester, the first and second polymer film layers 40, 12a may each include a biaxially oriented polyester to provide the food wrap 10a with an increased tensile strength and a resistance to tensile elongation. Preferably, the first and second polymer film layers 40, 12a are substantially transparent, however the first and second polymer film layers 40, 12a may also be provided in a translucent or opaque form depending upon the requirements of the applications, similar to the previously described polymer film layer 12. The second polymer film layer 12a includes a first surface 22a and a second surface 24a opposite the first surface 22a. The first polymer film layer 40 may also comprise a sealable polyester material such as a sealable, food-safe polyethylene terephthalate, thereby allowing the wrap 10a to be sealed to itself or other food packaging as described below. An example of the sealable, food-safe material for the first polymer film layer 40 may include OLYESTER® as available from Toyobo Co., Ltd. of Osaka, Japan. Preferably, the first polymer film layer 40 has a haze of about 4.5% at 13 μm and 6.0% at 30 μm; a tensile strength at break MD of about 170 Mpa and TD of about 190 Mpa at 13 μm, and MD of about 195 Mpa and TD of about 175 Mpa at 30 μm; a tensile elongation at break MD and TD of about 160% at 13 μm and about 170% at 30 μm; and a heat seal strength at 160° C., 2 kg, 2 sec. F/F of preferably between about 6 N/15 mm and about 10 N/15 mm and more preferably of about 8 N/15 mm at 13 μm, and B/B of preferably between about 10 N/15 mm and about 14 N/15 mm and more preferably of about 12 N/15 mm at 13 p.m. Alternatively, the first polymer film layer 40 may be replaced with a sealable coating applied to the first surface 22a of the second polymer film layer 12a. In the illustrated example, the first polymer film layer 40 includes a first surface 42 and a second surface 44 opposite the first surface 42, where the second surface 44 of the first polymer film layer 40 is attached to the first surface 22a of the second polymer film layer 12a. Preferably, the second surface 44 is attached to the first surface 22a via a coextrusion of the first and second polymer film layers 40, 12a may be utilized. However, alternative procedures or methods may be utilized, including, but not limited to adhesives, ultrasonic welding, heating and the like, wherein the first and second surfaces 22, 24 cooperate to define a thickness X′ of the polymer film layer 12 there between. Preferably, the combination of the first and second polymer film layers 40, 12a have a thickness X′ of within the range of between about 6 μm and about 30 μm, more preferably a thickness X′ of within the range of between about 10 μm and about 18 μm, and most preferably of about 12 μm. In another embodiment, the second polymer film layer 12a may be replaced with a film layer that in addition or alternatively to the polymer material, comprises nylon. When comprising nylon, the second film layer 12a may include nylon 6 or nylon 6,6, and may comprise a biaxially oriented nylon.

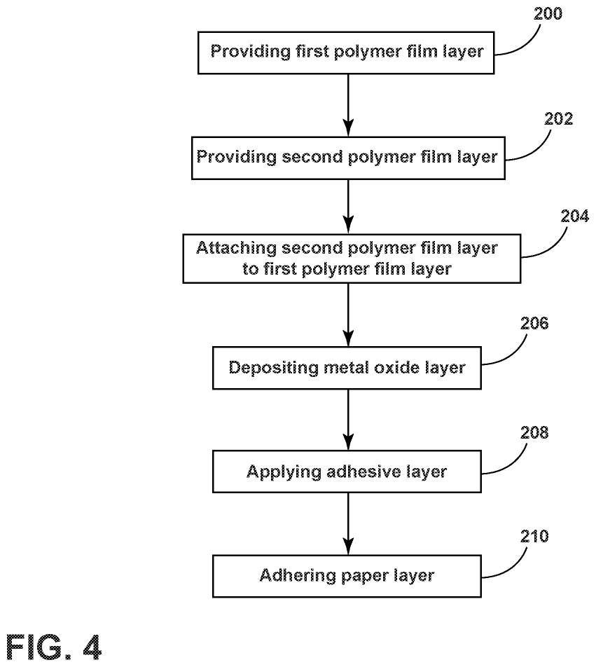

The food wrap 10a may be manufactured via a method (FIG. 4) that includes providing the first polymer film layer 40 (step 200), providing the second polymer film layer 12a (step 202), attaching the second polymer film layer 12a to the first polymer film layer 40 (step 204) depositing the barrier layer 14a on the second surface 24a of the second polymer film layer 12a via a vacuum metalizing process (step 206), applying the adhesive layer 16a to the combination of the first polymer film layer 40, the polymer film layer 12a and the barrier layer 14a (step 208), and adhering the paper layer 18a or a combination of the paper layer 18a, the ink label 19a and the overlay 20a to the combination of the first polymer film layer 40, the second polymer film layer 12a and the barrier layer 14a via the adhesive layer 16a via a dry lamination process (step 210).

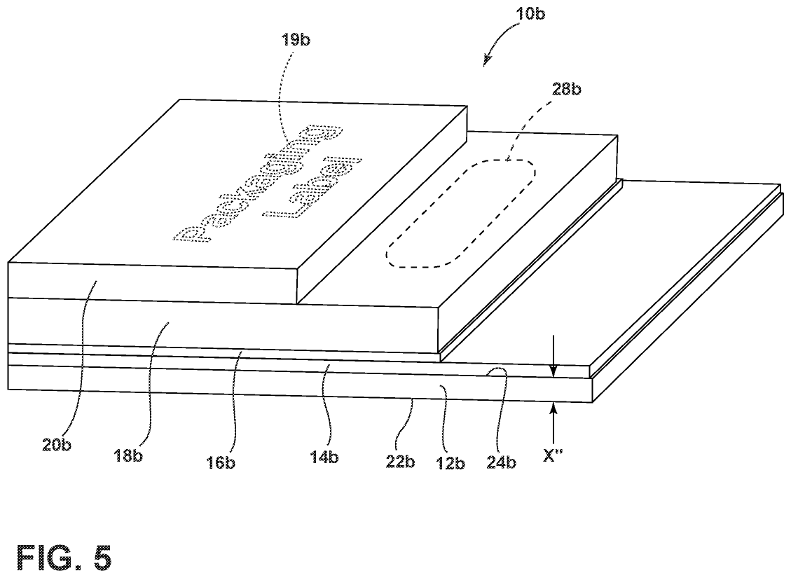

The reference numeral 10b (FIG. 5) generally designates a multi-layer food wrap also configured to wrap ovenable/heated foods, including foods heated via convection, conduction, radiant and microwave heating methods. In the illustrated example, the wrap 10b may include a food-safe, sealable polymer film layer 12b, a barrier layer 14b, an adhesive layer 16b, a paper layer 18b, and an ink label 19b, and a protective overlay 20b, where the barrier layer 14b, the adhesive layer 16b, the paper layer 18b, the ink label 19b and the protective layer 20b may be similar in composition and thickness as the corresponding and previously described barrier layer 14, the adhesive layer 16, the paper layer 18, the ink label 19 and the protective layer 20. In the illustrated example, the polymer film layer 12b may comprise polyester, and more particularly a food-safe, sealable polyester material such as OLYESTER® as available from Toyobo Co., Ltd. of Osaka, Japan. The polymer film layer 12b may comprise a material similar to that described above with respect to the first polymer film layer 40. When comprising polyester, the polymer film layer 12b may include a biaxially oriented polyester to provide the food wrap 10b with an increased tensile strength and a resistance to tensile elongation. Preferably, the polymer film layer 12b is substantially transparent, however the polymer film layer 12b may also be provided in a translucent or opaque form depending upon the requirements of the application. For instance, certain applications may require that the food packaged within the overall food wrap 10b be visible at least through certain or preselected portions of the overall food wrap 10b, while other portions of the overall food wrap 10b remain either translucent and/or opaque, as described below. As best illustrated in FIG. 5, the polymer film layer 12b includes a first surface 22b and a second surface 24b opposite the first surface 22b, wherein the first and second surfaces 22b, 24b cooperate to define a thickness X″ of the polymer film layer 12b there between. Preferably, the polymer film layer 12b has a thickness X″ of within the range of between about 6 μm and about 30 μm, more preferably a thickness X″ of within the range of between about 10 μm and about 18 μm, and most preferably of about 12 μm. In another embodiment, the polymer film layer 12b may be replaced with a film layer that in addition or alternatively to the polymer material, comprises nylon. When comprising nylon, the film layer may include nylon 6 or nylon 6,6, and may comprise a biaxially oriented nylon. Alternatively, the polymer film layer 12b may be coated with a sealable material.

The food wrap 10b may be manufactured via a method similar to the method as previously described in relation to food wrap 10 and as illustrated in FIG. 2.

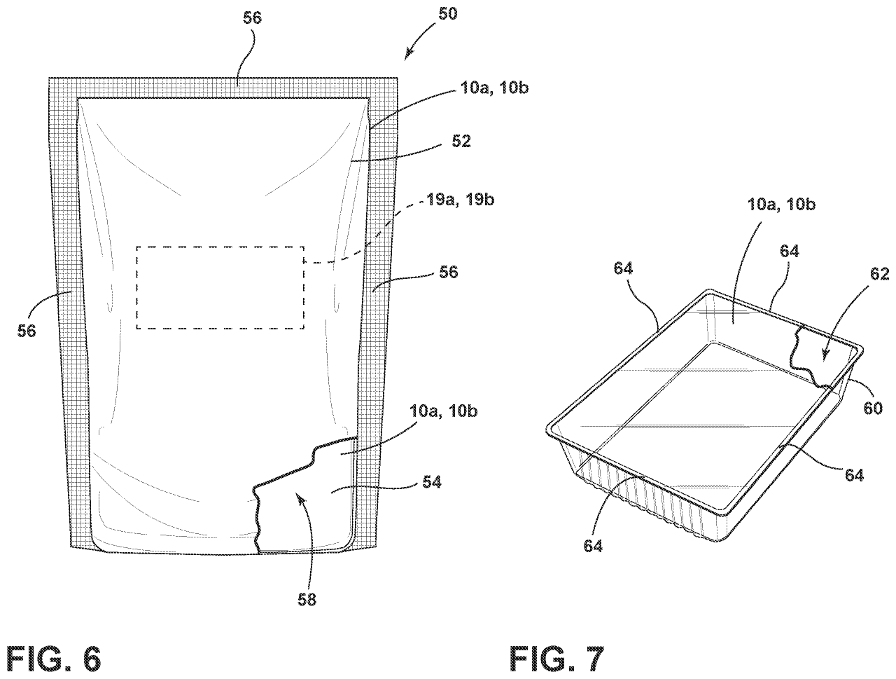

Either of food wraps 10a, 10b or a combination thereof may be utilized as a sealable, multi-layer food wrap, either to create bags or enclosures from the food wrap itself, or in conjunction with a separate container. As best illustrated in FIG. 6, a food bag 50 includes multiple layers of the food wrap 10a and/or the food wrap 10b, including a first layer 52 and a second layer 54. The second polymer film layer 12a of the wrap 10a and/or the polymer film layer 12b of the wrap 10b may be sealed to themselves or each other about one or more side edges 56 to define a storage area or compartment 58 within the food bag 50 for storing food stuffs therein. In the illustrated example, the second polymer film layer 12a of the food wrap 10a and/or the polymer film layer 12b of the food wrap 10b may be sealed via heat sealing via platen(s) and/or heated bars, ultrasonic heating, vibrational welding, and the like. These sealing methods may be utilized to form external seals and/or internal seals, a.k.a., A/A seals. It is noted that the food bag 50 may be partially formed with one of more side edges 56 of the food bag 50 being formed prior to the food stuffs being placed therein, with one or more side edges 56 then being sealed subsequent to placement of the food stuffs, or that the food stuffs may be wrapped with the food wraps 10a, 10b, and that the side edges 56 subsequently sealed.

FIG. 7 illustrates the food wraps 10a and/or the food wrap 10b utilized in conjunction with a separate container 60, where the food wraps 10a, 10b cooperate with the container 60 to define a storage area 62 configured to store food stuffs therein. In the illustrated example, the second polymer film layer 12a of the food wrap 10a and/or that polymer film layer 12b of the food wrap 10b may be sealed to an outer peripheral edge 64 via heat sealing via platen(s) and/or heated bars, ultrasonic welding, vibrational welding, and the like.

The present inventive food wrap and shown and described herein is configured to sufficiently wrap and store foods, such as sandwiches, in a point of sale presentation form while allowing for convection, conduction, radiant and microwave heating and providing improved heat retention and gas and moisture resistance, thereby resisting the propagation of liquids such as grease through the overall food wrap. The food wrap allows for direct convection, conduction, radiant and microwave heating of the wrapped foods while remaining within the food wrap, and simultaneously improve the ease of wrapping the food item and provides an aesthetically pleasing appearance where the food wrap provides the improvements noted above while displaying as “sandwich wrap” typically associated by customers with point of sale sandwich and other food displays. The food wrap is also configured to be sealed to itself and/or to separate food storage containers, thereby allowing the food wrap to be utilized to construct food storage bags and/or cooperate with the storage containers to store food stuffs therein.

In the foregoing description, it will be readily appreciated by those skilled in the art that modifications may be made to the embodiments disclosed herein without departing from the concepts of those embodiments. Such modifications are to be considered as included in the following claims, unless these claims by their language expressly state otherwise.

The invention claimed is:

1. A food wrap configured to be heated, comprising:
a sealable first polymer film layer having a first surface, a second surface opposite the first surface, wherein the first polymer layer comprises a sealable polymer material;
a second polymer film layer having a first surface covering the second surface of the first polymer film layer, and a second surface opposite the first surface of the second polymer layer;
a metal oxide layer covering at least a majority of one of the surfaces of the first and second polyester film layers; and
a paper layer coupled to the second polymer film layer and having a grammage of within a range of between about 25 g/m² and about 80 g/m².

2. The food wrap of claim 1, wherein the first polymer film layer comprises a sealable coating applied to the first surface of the first polymer layer.

3. The food wrap of claim 1, wherein at least one of the first and second polymer film layers comprises polyester.

4. The food wrap of claim 3, wherein the polyester comprises a biaxially oriented polyester.

5. The food wrap of claim 1, wherein the first and second polymer film layers cooperate to define a thickness that is between about 6 μm and about 30 μm.

6. The food wrap of claim 1, wherein the metal oxide comprises aluminum oxide.

7. The food wrap of claim 1, wherein the metal oxide layer is located between the second polymer film layer and the paper layer.

8. The food wrap of claim 1, wherein the food wrap is microwavable.

9. The food wrap of claim 1, wherein a first portion of the first polymer film layer and a second portion of the first polymer film layer are sealed to one another.

10. The food wrap of claim 1, wherein different portions of the first polymer film layer are sealed to one another such that the food wrap defines a storage compartment configured to receive food stuff therein.

11. The food wrap of claim 1, wherein the sealable first layer is configured to be sealed via heat sealing.

12. The food wrap of claim 11, wherein the first polymer film has a heat seal strength at 160°, 2 kg. and 2 seconds at 13 μm of about 8 N/15 mm.

13. A food wrap configured to be heated, comprising:
a food-safe, sealable polymer film layer having a first surface and a second surface opposite the first surface;
a metal oxide layer covering at least a majority of one of the surfaces of the sealable polyester film layer; and
a paper layer coupled to the second polymer film layer and having a grammage of within a range of between about 25 g/m² and about 80 g/m².

14. The food wrap of claim 13, wherein the sealable polymer film layer comprises polyester.

15. The food wrap of claim 13, wherein the thickness of the sealable polymer film layer is between about 6 μm and about 30 μm.

16. The food wrap of claim 13, wherein the metal oxide comprises aluminum oxide.

17. The food wrap of claim 13, wherein the metal oxide layer is located between the sealable polymer film layer and the paper layer.

18. The food wrap of claim 13, wherein the wrap is microwavable.

19. The food wrap of claim 13, wherein a first portion of the sealable film layer and a second portion of the sealable film layer are sealed to one another.

20. The food wrap of claim 13, wherein different portions of the sealable film layer are sealed to one another such that the food wrap defines a food storage compartment configured to receive food stuffs therein.

21. The food wrap of claim 13, wherein a first portion of the polymer film layer is configured to be sealed to a second portion of the polymer film layer.

22. The food wrap of claim 13, wherein the polymer film layer is configured to be sealed via heat sealing.

23. The food wrap of claim 22, wherein the sealable film layer has a heat seal strength at 160° C., 2 kg. and 2 seconds at 13 μm of about 8 N/15 mm.

24. A method for manufacturing a microwavable wrap for wrapping foods, comprising:
providing at least one food-safe, sealable polymer film layer having a first surface and a second surface opposite the first surface, the at least one polymer film layer;
covering at least a majority of one of the surfaces of the polymer film layer with a metal oxide layer;
providing a paper layer having a grammage of within a range of between about 25 g/m² and about 80 g/m²;
coupling the paper layer to the polymer film layer and the metal oxide layer; and
sealing a first portion of the at least one polymer film layer to a second portion of the at least one polymer film layer.

25. The method of claim 24, wherein sealing the first and second portions of the at least one polymer film layer creates a storage compartment configured to receive food stuffs therein.

26. The method of claim 24, wherein sealing the first portion to the second portion includes heat sealing.

27. The method of claim 26, wherein the heat seal strength of the polymer film layer at 160° C., 2 kg. and 2 seconds at 13 μm of about 8 N/15 mm.

28. A method for manufacturing a food storage arrangement, comprising:
providing at least one food-safe, sealable polymer film layer having a first surface and a second surface opposite the first surface;
covering at least a majority of one of the surfaces of the at least one polymer film layer with a metal oxide layer;
providing a paper layer;
coupling the paper layer to the at least one polymer film layer and the metal oxide layer;
providing a food container that is separate from the at least one polymer film layer, the food container having at least one side edge; and
sealing the at least one polymer film layer to the at least one side edge of the food container thereby defining a storage area for storing food stuffs therein.

29. The method of claim 28, wherein the step of sealing includes heat sealing.

30. The method of claim 29, wherein the polymer film layer has a heat seal strength at 160° C., 2 kg. and 2 seconds at 13 μm of about 8 N/15 mm.
